(19) United States
(12) Patent Application Publication
(10) Pub. No.: US 2026/0017812 A1
(43) Pub. Date: Jan. 15, 2026

(54) BINOCULAR VISION DEPTH COMPUTATION SYSTEM AND BRAIN-INSPIRED COMPUTATION MODEL

(71) Applicants: Yunjian BI, Hohhot (CN); Xiaofei BI, Beijing (CN)

(72) Inventor: Yunjian BI, Hohhot (CN)

(21) Appl. No.: 19/333,318

(22) Filed: Sep. 18, 2025

Related U.S. Application Data
(63) Continuation of application No. PCT/CN2024/075115, filed on Feb. 1, 2024.

(30) Foreign Application Priority Data
Jul. 16, 2023 (CN) 202310872732.9

(51) Int. Cl. G06T 7/593; G06T 7/90

(52) U.S. Cl. CPC G06T 7/593; G06T 7/90; G06T 2207/20084

(57) ABSTRACT

By means of constructing neuron-like models, the present application achieves neural information encoding, inter-neuron connection self-organization, and neural computation and output of depth estimation encoded information. A system and models provided in the present application comprise: constructing two paths of visual receptors; constructing a visual sequence model, which, under small-amplitude, reciprocating, irregular movements of the visual receptors, outputs visual sequence information; constructing a neural network model, which receives information input from the visual receptors, wherein the inputted information drives a basic neural model to operate. Under visual stimulation, light-receiving units of the visual receptors connect to the neural network in a self-organized manner, and color information and edge information of an object are separated and outputted; stimulation at a boundary line causes a general sequence model to operate.

### CROSS-REFERENCE TO RELATED APPLICATIONS

This application is a continuation of International Patent Application No. PCT/CN2024/075115 with a filing date of Feb. 1, 2024, designating the United States, now pending, and further claims priority to Chinese Patent Application No. 202310872732.9 with a filing date of Jul. 16, 2023. The content of the aforementioned applications, including any intervening amendments thereto, are incorporated herein by reference.

### TECHNICAL FIELD

The present application belongs to the technical field of cognitive neuroscience, with applications in passive vision depth computation and brain-inspired computing. More specifically, the application provides a neuronal binocular vision depth computation system and an associated brain-inspired computation model.

### BACKGROUND OF THE PRESENT APPLICATION

Among the existing passive visual depth estimation methods, computer stereo vision depth estimation is an important estimation method. In practical applications, the binocular stereo matching algorithms are key to depth estimation. The present application provides a brain-inspired computing stereo matching method and a binocular vision depth computation system based on the bio-electrical properties of neurons. Unlike the memory-computation separation algorithms of general computer systems, the present application constructs a brain-inspired computation model based on the fundamental functions of neurons, thereby enabling functions such as neuronal information encoding, self-organization of inter-neuronal connections, and output of encoded information through neuronal computation.

### SUMMARY OF THE PRESENT APPLICATION

The present application provides a binocular stereo-matching method for stereo vision and an associated brain-inspired computation model based on known neuronal characteristics, thereby offering a new method and system for binocular stereo-matching algorithms in stereo vision. The specific method and system include the following steps.

Step S1: A visual receptor receives external light stimuli to form a physical object boundary and generate color and orientation information of the object boundary. The binocular vision depth computation system first constructs two visual receptors which input perceived visual information into a neural network model.

Step S2: The visual receptors perform minor and irregular reciprocating motions to generate visual sequence pulses. The two visual receptors of the binocular vision depth computation system continuously perform minor and irregular reciprocating motions to acquire visual information from the objective world. Further, a visual sequence model is constructed. The light-receiving units of the visual receptor connect to the visual sequence model. The visual sequence model sequentially outputs visual information, and generates visual sequence pulses.

Step S3: visual color information and edge information are separated. The binocular vision depth computation system further constructs a basic neuron model (perceptual model). Pulses are input from the two visual receptors to the neuronal network, to stimulate the basic neuron model (perceptual model) to operate. During this period, the stimulus sequences received by basic neuron models (perceptual models) within continuous regions are stable. The signal excitation remains suppressed for a certain period due to inhibition by inhibitory neurons in the model. Basic neuron models (perceptual models) at edges or boundaries receive continuously changing stimulus sequences, forming sustained excitation. This enables separating the color information from the edge information.

Step S4: Processing, extraction, and integration of color information and orientation information at object edges form local edge neural pulse sequence information. The binocular vision depth computation system further constructs a general sequence model. The basic neuron models (perceptual models) at edges or boundaries are stimulated to trigger the operation of the general sequence model. Sequential excitation of points at edges or boundaries forms edge sequence combination pulses through the general sequence model. These pulses contain color sequence and orientation sequence information of the edge.

Step S5: The sequence-synchronized matching detection of binocular object edge information achieves output of stereo information. The binocular vision depth computation system further constructs a sequence matching model. The overall system receives inputs from both visual receptors, both forming corresponding edge sequences. Two sequences from both paths, due to independent processing, are the same but not synchronized. Under the action of these two same-sequence but asynchronous edge sequences, the sequence matching model operates, forming a new mode of excitation and outputting the original sequence. Under the action of two sequences that are not the same, the sequence matching model has no output. Under the action of two approximately same-sequence edge sequences, the sequence matching model outputs a short sequence. Outputting the original sequence represents foreground depth disparity; and outputting a short sequence represents foreground-background spacing.

### DESCRIPTION OF THE DRAWINGS

The present application will be further explained below in conjunction with the accompanying drawings.

FIG. 1 is a flowchart of a binocular vision depth computation system and a brain-inspired computation model according to the present application;

FIG. 2 is a side view of a visual receptor structure of a binocular vision depth computation system according to the present application;

FIG. 3 is a top view of a visual receptor structure of a binocular vision depth computation system according to the present application;

FIG. 4 is a structure schematic and construction step diagram of a visual sequence model of a binocular vision depth computation system and brain-inspired computation model according to the present application;

FIG. 5 is a schematic structure and construction step diagram of the basic neuron model (perceptual model) structure of a binocular vision depth computation system and brain-inspired computation model according to the present application;

FIG. 6 is a schematic structure and construction step diagram of the general sequence model of a binocular vision depth computation system and brain-inspired computation model according to the present application;

FIG. 7 is a schematic structure and construction step diagram of sequence matching model of a binocular vision depth computation system and brain-inspired computation model according to the present application;

FIG. 8 is a schematic structure and construction step diagram of an effector perceptual model of a binocular vision depth computation system and brain-inspired computation model according to the present application;

FIG. 9 is a schematic structure and construction step diagram of a logical perceptual model of a binocular vision depth computation system and brain-inspired computation model according to the present application;

### DETAILED DESCRIPTION OF PREFERRED EMBODIMENTS

To make the technical solution of the present application clearer and more comprehensible, the application is further described in detail below with reference to the accompanying drawings.

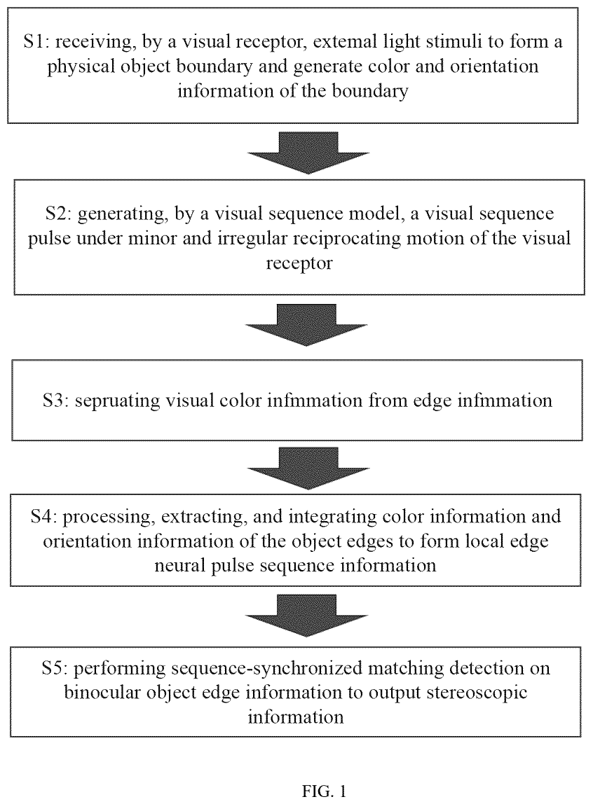

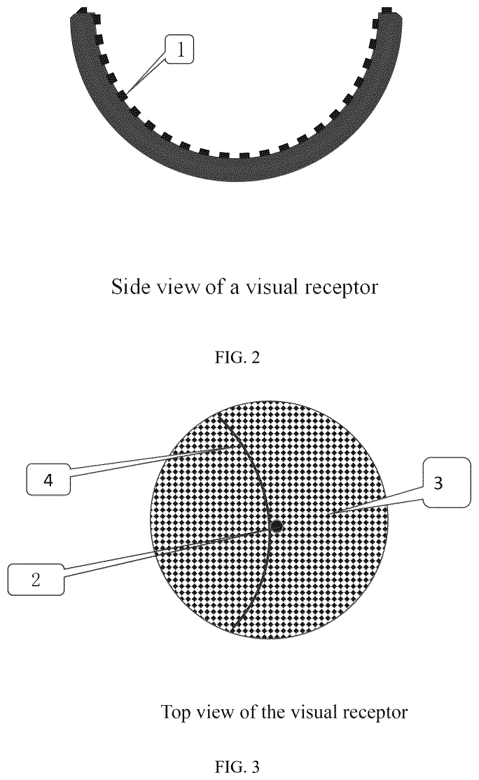

Furthermore, the visual receptor described in step S1 of FIG. 1, which receives external light stimuli to form logical representation of object boundaries and generate associated color and orientation information, may be implemented through the visual receptor illustrated in FIGS. 2 and 3. The characteristics of the visual receptor are as follows.

The binocular vision depth computation system of the present application employs a pair of visual receptors which synchronously perform minor and irregular reciprocating motion. The pair of visual receptors simultaneously output color information sequences of the objective world's colors and boundaries. The single structure of the receptor is specifically shown in FIGS. 2 and 3.

FIG. 2 is a side view of the visual receptor. The model has a concave structure with uniformly distributed light-receiving units on its inner surface, as indicated by label 1 in FIG. 2. These illustrated light-receiving units receive external visible light and electromagnetic wave stimuli and convert them into electrical signals.

The visual receptor performs minor and irregular reciprocating motion, which causes the background within the model to constantly change. The color difference between the foreground and background forms a logical line of change, referred to as the object boundary herein, as shown in FIG. 3.

FIG. 3 is a top view of the visual receptor. Label 4 in FIG. 3 indicates the curve formed by the imaging of an external straight line on the visual receptor. Label 2 indicates the center of the visual receptor. Label 3 indicates the uniformly distributed light-receiving units.

During synchronous minor and irregular motions of the visual receptors, the light-receiving units at points on the boundary line formed between the foreground object and the background are intermittently excited in sequence, forming a color change sequence of the boundary line.

Additionally, straight lines formed by object boundaries in the objective world are imaged as curves on the visual receptor. During synchronous minor and irregular motions of the receptor, the color change rate of the light-receiving units at different points on the imaged curve varies. Specifically, boundary points closer to the center of the visual receptor move at speeds closer to the actual boundary motion speed; and points farther from the center move at speeds that deviate more significantly from the actual boundary motion speed. Therefore, the difference in the rate of signal variation formed at the boundary on the visual receptor contains orientation information about the object boundary in the objective world. Furthermore, the reciprocating motion generates both radial and latitudinal motion components, causing sequential excitation of boundary points.

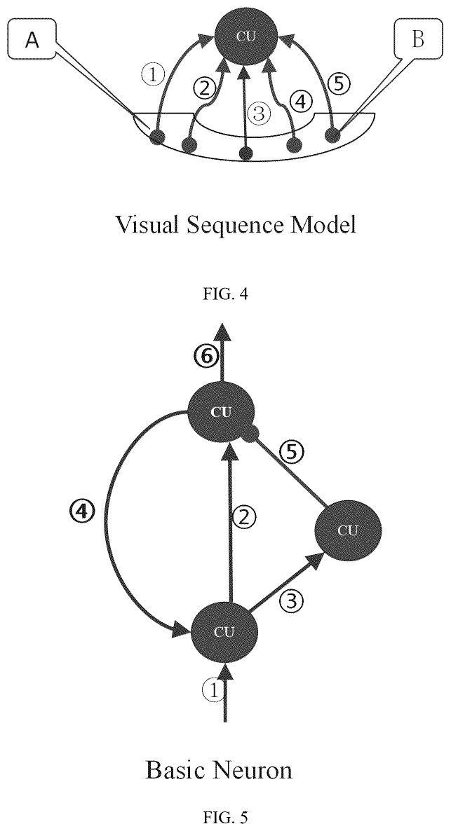

Further, “generating, by a visual sequence model, a visual sequence pulse under minor and irregular reciprocating motion of the visual receptor” as described in step S2 of FIG. 1 requires processing by the visual sequence model illustrated in FIG. 4. The color stimuli formed by the visual receptor undergo processing through the visual sequence model consisting of horizontal neuron, thereby forming neuronal color information pulse sequences.

The horizontal inhibitory neuron includes at least two input pathways from light-receiving units of the visual receptor. It includes one horizontal convergence unit to which all signal pathways connect. When the horizontal convergence unit receives a pulse electrical signal from any input pathway, it inhibits electrical signals from all other input pathways. After a certain interval, or horizontal convergence unit being stimulated with a certain capacity, the horizontal inhibitory neuron suppresses the current input signal, allowing it to receive signals from other pathways. This loop process creates alternating access of multiple input signals to the horizontal inhibitory neuron.

The visual sequence model consists of one horizontal inhibitory neuron connected to multiple local light-receiving units in the visual receptor. This model receives and processes external visual signals to generate sequentially excited output signals from multiple light-receiving units, thereby logically forming an excitation sequence. The specific computation process of this model is illustrated in FIG. 4.

FIG. 4—Visual Sequence Model: “CU” represents the horizontal inhibitory neuron convergence unit. Label A represents the visual receptor. Label B represents the light-receiving units of the model. Labels 1, 2, 3, 4, 5 represent the neuronal connection pathways from the light-receiving units to the horizontal inhibitory convergence unit. When the convergence unit receives an excitation signal from any of pathways 1, 2, 3, 4, or 5, it sends an inhibitory signal back through the same pathway to the remaining pathways. The inhibitory signal inhibits all pathways except the one that first transmitted the excitation signal. After excitation in the current excitation pathway ceases, other remaining pathways randomly generate excitation and inhibit all other pathways. This logically forms a sequential output of electrical signals from the light-receiving units.

Further, step S3 of FIG. 1, “achieving separation of visual color information and edge information” requires the collaborative processing of artificial neuron, artificial neuronal network, and the basic neuron model shown in FIG. 5.

The artificial neuron is divided into an excitatory artificial neuron and an inhibitory artificial neuron. Their characteristics are as follows.

The excitatory artificial neuron receives excitatory inputs and outputs excitatory signals. It has at least three input signal pathways, of which at least two are excitatory pathways and at least one is an inhibitory pathway. It has at least two output signal pathways, which are all excitatory. When the pulse signals carried by input pathways or the excitation effects operate at high frequency, or the connected target neuron convergence unit maintains in a sustained high-excitation state, the input pathway efficiency increases and maintains for a certain time. The excitatory artificial neuron convergence unit transmits excitatory pulse signals to all output pathways.

The excitatory artificial neuron has one convergence unit. The convergence unit aggregates signal levels and delays the output pulse signal. It receives pulse signals from all input pathways, aggregates them to a certain level, and then emits a pulse signal to all output pathways. Upon receiving signals from a high-efficiency input pathway, the convergence unit shortens or even eliminates signal delay, thereby rapidly emitting pulses to the output pathway.

The inhibitory artificial neuron receives excitatory inputs and outputs inhibitory signals. It has at least two input signal pathways, of which at least one is excitatory and at least one is inhibitory. It has at least one output signal pathway, which are all inhibitory. When the pulse signals carried by the input pathway or the excitation effect operates at high frequency, or when the connected target neuron convergence unit is in a sustained high-excitation state, the efficiency of the input pathway increases and sustains for a predetermined duration. The output pathways of the inhibitory artificial neuron may sense the excitation level of the connected neuron convergence unit. The inhibitory efficacy of the output pathway has a positive linear relationship with the excitation level of the connected convergence unit.

The artificial neuron has one convergence unit. The convergence unit aggregates signal levels and delays the output pulse signal. It receives pulse signals from all input pathways, aggregates them to a certain level, and then emits a pulse signal to all output pathways. When receiving signals from high-efficiency input pathways, the delay shortens or even disappears, quickly emitting pulses to output pathways. The convergence unit of the inhibitory artificial neuron transmits inhibitory pulse signals to all output pathways.

When convergence units of excitatory and inhibitory artificial neurons receive inhibitory pulse signals from input pathways, the inhibitory signals are aggregated at the convergence unit, reducing the probability of the convergence unit outputting a pulse signal.

The convergence units of excitatory and inhibitory artificial neurons do not output pulse signals without external signal input.

When the convergence units of excitatory and inhibitory artificial neurons receive excitatory signals from input pathways, the excitatory signals are aggregated at the convergence unit, resulting in an increased probability of signal output from the convergence unit; or direct signal transmission through output pathways.

Further, when the input pathway is an initial pathway, there is a time delay between the input signal and the corresponding signal generated by the convergence unit; and when the input pathway is a high-efficiency pathway, the time delay is shortened or even eliminated.

When the convergence units of excitatory and inhibitory artificial neurons receive excitatory signals through input pathways, long-sequence signals or signals from high-efficiency pathways exhibit stronger cumulative effects, making it easier to excite the output pathway to output a signal.

The convergence units of excitatory and inhibitory artificial neurons may simultaneously receive excitatory signals from two or more input pathways. If excitation signals from multiple input pathways are temporally synchronized, each input pathway produces equivalent effects to single-pathway input, the convergence unit generates output pulses without superimposed enhancement. If the excitation signals from multiple input pathways are temporally asynchronous, the inputs cause signal enhancement at the convergence unit.

Further, the above “artificial neuronal network” has the following characteristics.

The artificial neuronal network consists of excitatory artificial neurons and inhibitory artificial neurons interconnected via input and output pathways. Each excitatory artificial neuron is connected to at least one surrounding excitatory artificial neuron and one inhibitory artificial neuron model. Each inhibitory artificial neuron is connected to at least one excitatory artificial neuron as output and at least one excitatory artificial neuron as input. In the artificial neuronal network, all artificial neurons have the potential to be connected to other neurons.

Further, under the influence of external stimuli, the artificial neuronal network autonomously forms, at a local mesoscopic level, the basic neuron model (perceptual model), general sequence model, sequence matching model, effector perceptual model, and logical perceptual model.

The basic neuronal model, also known as the perceptual model, is referred to in this application as the basic neuron model (perceptual model). Its characteristics are as follows: the basic neuron model (perceptual model) is formed by a local excitatory source neuron, an excitatory target neuron, and an inhibitory neuron in the neuronal network model, interconnected in an initial state. When receiving external stimulus signals, it forms an interconnected loop. Under the action of the loop, the pathway between the source and target neurons carries signals at a higher frequency, and the target neuron signal accumulates continuously, thus forming enhanced transmission efficiency. Meanwhile, under the action of the inhibitory loop, the model achieves separated signal output. The specific operation process of the model is shown in FIG. 5:

In FIG. 5 of the basic neuron model (perceptual model) in FIG. 5: label CU 1 represents a convergence unit of the excitatory source neuron, label CU 2 represents a convergence unit of the excitatory target neuron, label CU 3 represents a convergence unit of the inhibitory neuron, arrowed lines represent pathways between neurons, numbered 1, 2, 3, 4, 5, 6, the pathways 1, 2, 3, 4, 6 are excitatory pathways carrying excitatory signals, and the pathway 5 is an inhibitory pathway carrying inhibitory signals.

Under the condition of interconnected neuron models in the neuronal network model, a local excitatory source neuron, an excitatory target neuron, and an inhibitory neuron form the basic neuron model (perceptual model) through initial state connections, as shown in FIG. 5. At this stage, the basic neuron model (perceptual model) is in its first-stage initial state. Except for Pathway 1, all other pathways remain in their initial effect stage. No signal transmission occurs in these pathways. The transmission efficiency of all pathways remains unchanged.

Further, the basic neuron model (perceptual model) enters its second stage (initial excitation state). A pulse signal input through pathway 1 passes directly through the convergence unit (CU 1) of source neuron and accumulates through pathway 2 at the convergence unit (CU 2) of the target neuron. Meanwhile, the pulse signal input through pathway 1 also passes directly through CUI and accumulates through pathway 3 at the convergence unit (CU 3).

Further, the basic neuron model (perceptual model) enters its third stage (loop formation state). When signal accumulation in the convergence unit (CU 2) through pathway 2 reaches a certain threshold, a pulse signal is generated in pathways 4 and 6. When signal accumulation in the convergence unit (CU 3) through pathway 3 reaches a certain threshold, an inhibitory pulse signal is generated in pathway 5. The inhibitory signal in pathway 5 suppresses the excitatory pulse signals in pathways 4 and 6. Due to the accumulation effect at CU 3, the inhibitory signal from pathway 5 is delayed relative to the excitatory signal from pathway 2 generated at CU 1. In the early stage of the loop, the inhibitory effect of pathway 5 is weaker than the excitatory effect of pathway 2.

Further, the basic neuron model (perceptual model) enters its fourth stage (high-frequency feedback state). The efficacy of pathway 4 improves. Under the combined action of the pulse signal in Pathway 4 and the input pulse signal in Pathway 1, the frequency of pulse signals in pathways 2 and 3 accelerates, leading to faster accumulation effects at CU 2 and CU 3. The high-frequency signal in Pathway 2 accelerates signal accumulation at CU 2, which in turn increases the signal frequency in Pathway 4. Pathways 2 and 4 form a positive feedback loop, and the signal frequency in this loop continuously increases. Additionally, the signal transmission frequency in pathway 3 also increases. Due to accumulation at CU 2, the signal in pathway 4 lags behind those in pathways 2 and 3.

Further, the basic neuron model (perceptual model) enters its fifth stage (pathway gain state). A positive feedback loop pathway is formed between pathways 2 and 4. The overall signal frequency of the feedback loop continuously increases. Under the action of high-frequency signals, the accumulation effects at CU 2 and CU 3 continue to increase in pathways 2 and 3, which gradually become high-efficiency excitatory pathways. In these pathways, signal transmission delay at the convergence units CU 2 and CU 3 is shortened or even eliminated.

Additionally, the basic neuron model (perceptual model) enters a pathway inhibition enhancement State. Pathway 5 (the inhibitory pathway) has an electronic pathway for synchronizing potential. The stimulus level from pathway 2 increases the potential level at the convergence unit (CU 2). Under potential synchronization, the inhibitory effect of pathway 5 gradually strengthens. However, a time latency exists between the efficiency increase of pathway 5 and that of pathway 2. Therefore, during the rising phase of signal frequency in the overall loop system, the inhibitory effect of pathway 5 is weaker than the excitatory stimulation of pathway 2. Only after the signal frequency of the overall loop system reaches a high-frequency state and stabilizes for a certain time, the inhibitory effect of pathway 5 and the excitatory effect of pathway 2 reach an excitation-inhibition balance at the convergence unit (CU 2).

Further, the basic neuron model (perceptual model) enters its sixth stage (model formation state). After the inhibitory effect of pathway 5 in the high-frequency state and the excitatory effect of pathway 2 reach the excitation-inhibition balance, the inhibitory effect of pathway 5 rapidly suppresses signal transmission in the loop system. Pathways 2, 3, 4 reach a high-efficiency communication state, and the model enters a stable state.

Further, the basic neuron model (perceptual model) enters its sixth stage (working state). After the model forms the high-efficiency transmission state of pathways 2 and 3, the inhibitory effect of pathway 5 enters a high-efficiency state. However, compared to the excitatory effect of pathway 2, there is a latency in Pathway 5 inhibition still exhibits a latency during the initial phase of system signal transmission. Under a stimulus from pathway 1, the system transmits the original sequence carried by Pathway 1. However, in the later stage of sustained transmission, signals from pathway 1 cannot be transmitted out through pathways 4 and 6.

In the formation of other brain-inspired computing functional models, the basic neuron model (perceptual model) is also the basic model for establishing high-efficiency connections between source and target neurons. The basic model encompasses different excitation conditions for convergence unit CU 2. These conditions include, but are not limited to: 1. After being excited by high-efficiency pathways from other neurons, a temporarily high-level potential is produced, the convergence unit CU 2 is in an easily excitable state. Stimulation by other ordinary connection pathways may then stimulate the convergence unit CU 2 to produce excitation; 2. After an ordinary connection pathway connects to the convergence unit 2, a long sequence or repeated sequence stimulus causes excitation at the convergence unit 2 due to the cumulative effect; 3. When two ordinary pathways connect to the convergence unit 2 and act simultaneously on the convergence unit 2, two stimuli are the same sequence yet asynchronous, or approximately the same sequence yet asynchronous, causing excitation at the convergence unit 2; 4. During sustained stimulation from reverse connection of other neurons having established high-efficiency pathways to the convergence unit 2, an easily excitable state is formed, leading to excitation at the convergence unit 2; 5. The convergence unit 2 is in an easily excitable state during high-frequency excitation within a signal loop.

Further, Step S3 of FIG. 1, “separating visual color information from edge information” refers to the process in which the neuronal network model receives electrical signal stimuli from the visual receptor, thereby causing the formation and operation of the basic neuron model (perception model). During this period, the stimulus sequences received by the basic neuron models (perception models) within uniform regions are stable, are inhibited by inhibitory neurons and remain in an inhibited state within a certain time. The stimulus sequences received by the basic neuron models at edges or boundaries vary continuously and forms an excitation. This creates a temporal distinction that separates color patterns from edge patterns.

Further, step S4 of FIG. 1, “processing, extracting, and integrating of the color and the orientation information of object edges to form local boundary neural pulse sequence information” requires collaborative processing by the neuron model, the neuronal network model, and the neuron mesoscopic model. The neuron model and neuronal network model are the same as those described in Step S3. The neuron mesoscopic model processes information by using the general sequence model and sequence matching model.

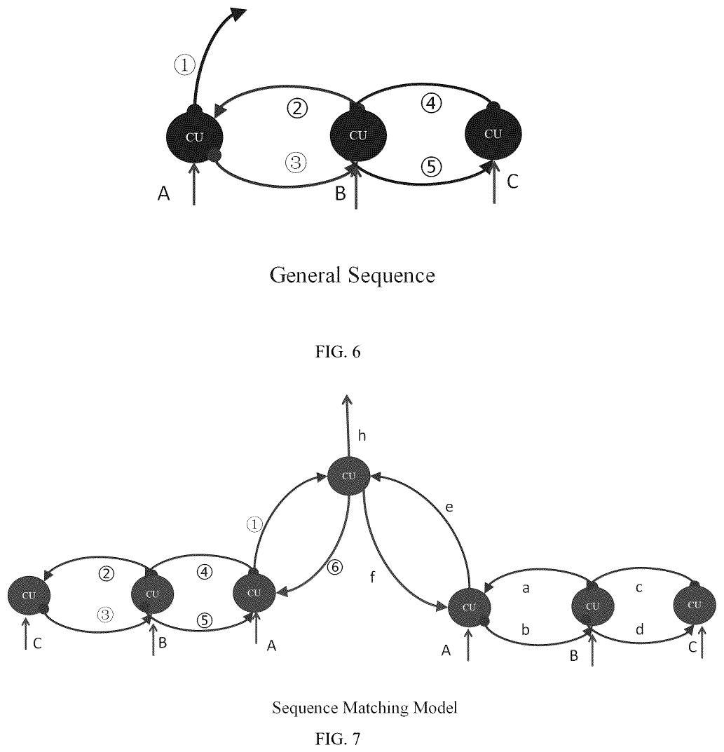

The general sequence model is characterized by including multiple sequentially excitatory neurons connected in sequence, and outputting sequence signals after processing. The specific model operation process is shown in FIG. 6:

In FIG. 6, Label CU 1 represents the convergence unit of the first excited excitatory neuron. Label CU 2 represents the convergence unit of the second excited excitatory neuron. Label CU 3 represents the convergence unit of the third excited excitatory neuron. Arrowed lines represent pathways between neurons, numbered 1, 2, 3, 4, 5. All pathways 1, 2, 3, 4, 5 are excitatory pathways for carrying excitatory signals. Labels A, B, C represent sequential stimuli received by the neurons. The figure shows only three sequentially excited neurons. In practice, more may be added by analogy.

The first stage of the general sequence model: The first neuron in the sequence is excited to receive sequence stimulus. It emits pulse signal A through pathway 1. The convergence unit enters a ready-to-excite state. The second stage of the general sequence model: the second neuron in the sequence is excited to connect to the convergence unit CU 1 of the first neuron (which is exciting or has excited) through initial state pathway 2. Since CU 1 is in a ready-to-excite state, neuron 1 is excited again. Sustained sequence stimuli via pathway 2 enables the formation of a feedback Pathway 3, resulting in a feedback loop between pathways 2 and 3. The third stage of the general sequence model: the loop formed by pathways 2 and 3 generates high-frequency stimulation, thereby optimizing the transmission efficiency of pathway 2. The mechanism for forming high-efficiency transmission pathways in this model is the same as that of the basic neuron model (perceptual model). The excitation-inhibition loop is not described in detail again. There are inhibitory pathways between each segment of neuron connections in FIG. 6, and their operation is the same as the inhibitory pathways in the basic neuron model. However, these inhibitory connections are not shown in FIG. 6. When the next A, B, C sequences are excited, pathway 1 transmits the A+B sequence.

The forth stage of the general sequence model: a third neuron in the temporal sequence is excited, it connects to the convergence unit 2 of a second neuron which has been excited via pathway 4. Since the convergence unit 2 is at a high potential, the second neuron is excited again. Sustained sequence stimulus via pathway 4 forms a feedback pathway 5. Pathways 4 and 5 form a feedback loop. The fifth stage of the general sequence model: The loop formed by pathways 4 and 5 generates high-frequency stimuli, making pathway 4 highly efficient. When the next A, B, C stimulus sequence appears, pathway 1 transmits the A+B+C sequence. By analogy, more sequentially excited neurons in the general sequence model may generate corresponding stimulus sequences.

The sequence matching model is characterized by comprising two excitatory neuronal sequence chains. After processing, it outputs the original sequence signal. The specific model operation process is shown in FIG. 7:

In FIG. 7, Label CU 1 represents a convergence unit of a first excited excitatory neuron of the excitatory neuron sequence chain in the general sequence model. Label CU 2 represents a convergence unit of a second excited excitatory neuron of the excitatory neuron sequence chain in the general sequence model. Label CU 3 represents a convergence unit of a third excited excitatory neuron of the excitatory neuron sequence chain in the general sequence model. Arrowed lines represent pathways between neurons, numbered 1, 2, 3, 4, 5, 6. All pathways 1-6 are excitatory pathways for carrying excitatory signals. Labels A, B, C represent sequence stimuli received by each neuron. Pathways 3 and 5 are high-efficiency pathways. Convergence units CU 1, CU 2, CU 3 have formed the excitatory neuron sequence chain of the general sequence model via pathways 3 and 5. Label CU 7 represents a convergence unit of the matching neuron in the sequence matching model. Label h represents an output pathway of the sequence matching model.

The mechanism for forming high-efficiency pathways in this model is the same as in the basic neuron model; the excitation-inhibition loop is not described in detail again.

In FIG. 7, CU 4 represents the convergence unit of the first excited excitatory neuron in the excitatory neuron sequence chain of the second general sequence model. CU 5 represents the convergence unit of the second excited excitatory neuron in the excitatory neuron sequence chain of the second general sequence model. CU 6 represents the convergence unit of the third excited excitatory neuron in the excitatory neuron sequence chain of the second general sequence model. The arrowed lines represent neural pathways, labeled a, b, c, d, e, f, all of which are excitatory pathways where excitatory signals are transmitted. Labels A, B, C denote sequential input stimuli received by the neurons. Pathways a and c are high-efficiency pathways, and the neuron convergence units 4, 5, 6 have already formed an excitatory neuron sequence chain of the general sequence model via pathways a and c. Each segment of neural connection in FIG. 7 has corresponding inhibitory pathways, and operates similarly to the inhibitory pathways in the basic neuron model, which is not depicted here. The mechanism for forming high-efficiency pathways in this model is identical to that of the basic neuron model (perceptual model). The excitation loop and the inhibition loop are not described in detail again.

First Stage-Initial State of the Sequence matching Model: convergence units 1, 2, 3 generate an output sequence A+B+C, convergence units 4, 5, 6 also generate an output sequence A+B+C under the same stimulus. Although the two sequences are identical, they arrive at convergence unit 7 asynchronously due to differences between the convergence units.

Second Stage-Output State of the Sequence matching Model: when two sequences act on the convergence unit 7, if the sequence signals carried by the two sequence 1 and e channels are in the same sequence but the time of reaching the convergence unit 7 is not synchronized, a continuous high-frequency stimulus is formed in the convergence unit 7, they produce a simultaneous detection effect and sequence accumulation. Feedback loops are formed in pathways 1 & 6 and e & g, respectively. Under high-frequency stimuli within their respective feedback loops, pathway effect gains land e each transition into a high-efficiency transmission state. However, the 1 & 6 loop and the e & f loop sequentially reach the high-efficiency state. Under the constraints of the loop reaching the high-efficiency first together with its inhibitory pathway, the loop reaching the high-efficiency state later becomes suppressed, which results in no signal output at the convergence unit 7. Thus, the signal sequence transmitted through pathway h becomes identical to the sequence carried by the loop reaching the high-efficiency state first.

Further, Step S4 of FIG. 1, “processing, extracting, and integrating color information and orientation information of the object edges to form local edge neural pulse sequence information” is the operation of the general sequence model caused by continuous excitation of stimulus sequences received by the basic neuron models at edges or boundaries. Sequential excitation of points at edges or boundaries forms edge sequence combination pulses via the general sequence model. These pulses include color sequence information and orientation sequence information of edges. Additionally, during Step S4, sequences formed by the basic neuron model within continuous regions also trigger the operation of the sequence matching model and general sequence model to form a regionally unified color information sequence. Under the integration of the general sequence model and sequence matching model, all color sequences within the region are output as the original color sequence, which is the color perception mode output.

Further, Step S5 of FIG. 1, “performing sequence-synchronized matching detection on binocular object edge information to output stereoscopic information” requires processing by the sequence matching model.

Further, the system receives inputs from both visual receptors, each generating its corresponding edge sequence. Due to independent processing, identical sequences from both pathways are the same but not synchronized. Under the action of these two same-sequence but asynchronous edge sequences, the sequence matching model operates to form a new mode of excitation and output the original sequence. Under the action of two sequences that are not the same sequence, the sequence matching model has no output. Under the action of two approximately same-sequence edge sequences, the sequence matching model outputs a short sequence. Outputting the original sequence represents foreground depth disparity; and outputting a short sequence represents foreground-background spacing.

The application also provides learning model in which the neural network acquires both the use of effectors and the application of logical concepts. Below are the operating principles of the corresponding models.

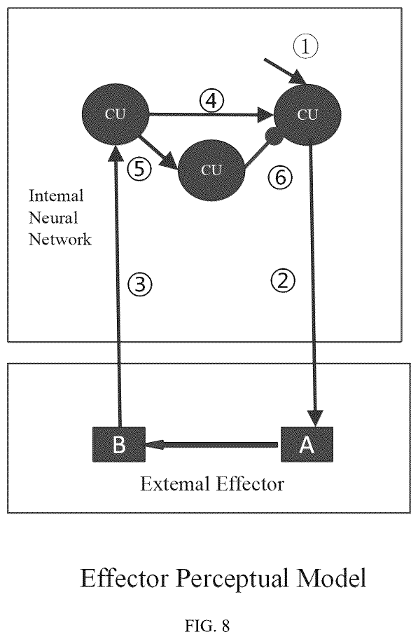

The effector perceptual model is characterized by forming neural action patterns or memories within the neural network (i.e., establishing a high-efficiency connection between sensory neurons and action planning neurons) through an interaction between an external effector (e.g., a wrist joint formed by muscles and bones) and the internal neural network. The external effector forms a loop connection with the sensory neurons and action planning neurons. The pulse signal or excitation signal formed under stimulation is transmitted at high frequency within the loop. The neuronal connection between the sensory neurons and action planning neurons become highly efficient under the action of high-frequency pulse signal or excitation signal. The specific model formation and operation process is shown in FIG. 8:

In FIG. 8, Label “CU 1” represents the convergence unit of the sensory neurons in the effector perceptual model, Label CU 2 represents the convergence unit of action planning neurons. Label CU 3 represents the convergence unit of inhibitory neurons. Label A represents an action part of the external effector. Label B represents an externalized part of the external effector. The arrowed line from A to B represents the driving linkage between external effectors, while the other arrowed lines represent neural pathways, numbered 1, 2, 3, 4, 5, and 6. Pathways 1, 2, 3, 4, and 5 are excitatory pathways transmitting excitatory signals, whereas pathway 6 is a inhibitory pathway transmitting inhibitory signals. Pathways 1, 2, and 3 are already formed high-efficiency pathways, while pathways 4 and 5 are in their initial state. In FIG. 8, each segment of neural links has corresponding inhibitory pathways, except for the inhibitory bypass between CU 1 and CU 2. The accompanying inhibitory bypasses for other excitatory pathways are not depicted or described.

First stage of the effector perception model: the action planning neurons (CU 2) are stimulated to activate pathway 2, pathway 2 drives the action part of the external effector. The action part A changes the externalized part B. The externalized part B of the effector then outputs a stimulus, to excite sensory neurons in the neural networks. CU 2 remains in a easily excitable state under the sustained stimulation of pathway 1.

Second stage of the effector perception model: the sensory neurons in the neural network are excited to send signals outward, the signals excite the action planning neurons (CU 2) that are at a high potential level. A loop is formed among the sensory neurons, action planning neurons, and effector. In the loop, signals self-excite and high-frequency signals are generated. The pathway between sensory neurons and action planning neurons becomes highly efficient. Additionally, under the increasing efficiency of the inhibitory neuron bypass, the looped signal gradually reach a balanced state and eventually enter a resting state.

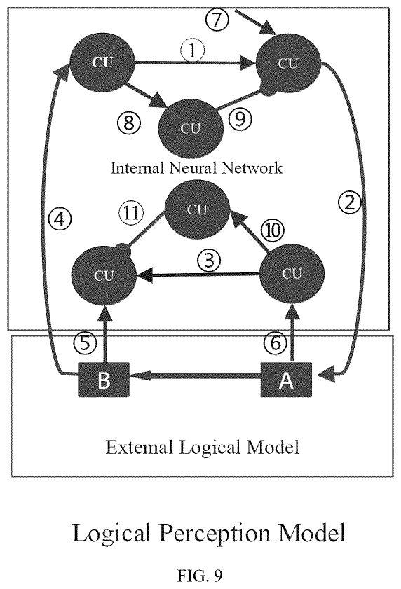

The logical perception model is characterized in that: the interaction between external logic and the internal neural network forms logical neural connections within the neural network, the operation of external logic forms a loop connection with the neural network, signals driven under stimuli are transmitted at high frequency within the loop. Additionally, the cause-and-effect of the logic is mapped into distinct neural patterns within the neural network, thereby forming high-frequency signal connections. The neural connections mapping the cause-and-effect of logic in the neural network become highly efficient under the influence of high-frequency signals. The specific formation and operation process of the model are illustrated in FIG. 9.

In FIG. 9: Label CU 1 represents the convergence unit of the neuron formed in the neural network mapping the “result” of the external logical model. Label CU 2 represents the convergence unit of the neuron formed in the neural network mapping the “cause” of the external logical model. Label CU 3 represents the convergence unit of the “consequence” neuron. Label CU 4 represents the convergence unit of the “intention” neuron. Labels CU 5, CU 6 represent convergence units of inhibitory neurons. Label A represents the cause part of the external logic. Label B represents the result part of the logic. The arrowed line from A to B represents the logic of the external logic. Other arrowed lines represent pathways between neurons, numbered 1 to 11. Pathways 1, 2, 3, 4, 5, 6, 7, 8, 10 are excitatory pathways transmitting excitatory signals; pathways 9, 11 are inhibitory pathways transmitting inhibitory signals. Pathways 2, 4, 5, 6, 7 are already formed high-efficiency pathways; pathways 1, 3, 8, 10 are in the initial state. Inhibitory link pathways exist between each segment of neuronal connections in FIG. 9. Apart from the inhibitory bypass between CU 2 and CU 1, and the inhibitory bypass between CU 3 and CU 4, the accompanying inhibitory bypasses for other excitatory pathways are not drawn or described.

In the first stage of the Logical Perceptual Model: the cause end (A) and result end (B) of the external logical model are separately mapped within the neuronal network to form distinct neuronal patterns, i.e., mapping connections are formed in the neural network with the neuron convergence units CU 1 and CU 2.

In the second stage of the logical perception model, the intention pattern neuron convergence unit (CU 4) drives the cause end of the external logical model, which in turn drives the result end. The result end activates the consequence pattern (the convergence unit CU 3) within the internal neural network. Under the sustained stimulation of the intention stimulus pathway 7, CU 4 remains in a easily excitable state. The activation of CU 3 further excites the easily excitable CU 4, forming an excitation loop. High-frequency signals are transmitted within this logical application loop, causing pathway 1 to become a high-efficiency pathway.

In the third stage of the logical perception model, the loop transmission of high-frequency signals in the logical application loop causes the cause end A and result end B to recurrently excite their corresponding CU 2 and CU 1, thereby resulting in high-frequency signals between CU 2 and CU 1, ultimately transforming pathway 3 between CU 2 and CU 1 into a high-efficiency pathway and establishing the internal logical model within the neural network.

In this embodiments, the binocular vision depth computation system and brain-inspired computation model described in this application are physically realized through dedicated hardware components designed to perform bio-inspired neural processing. The system architecture includes the following physical implementations.

In this embodiments, the visual receptors are implemented as active-pixel CMOS or CCD sensor arrays mounted on concave substrates. Each sensor contains a high-density grid of photodiodes with individual analog front-ends for converting visible/IR light into graded electrical signals. These sensors are mechanically coupled to precision micro-actuators (piezoelectric or MEMS-based) that induce controlled, irregular reciprocating motions with amplitudes below 0.5 mm and frequencies over 5 Hz, creating the necessary spatiotemporal stimulus patterns for edge detection.

In this embodiments, the brain-inspired computation model and system described above operate on an analog-digital mixed integrated circuit. The circuit includes a spiking neural network including memristor crossbar arrays configured to achieve millisecond-level dynamic synaptic weight adjustment through resistance switching, and time-to-digital converters (TDCs) coupled to spiking neuron circuits. These TDCs are configured to utilize pulse generation to emulate excitatory and inhibitory interactions.

In this embodiments, the effector perceptual model interfaces with external actuators through: high-speed serial peripheral interfaces (SPI/LVDS) transmitting motor commands as pulse-frequency modulated (PFM) signals. Optical encoders provide joint position feedback to creat the sensory-motor loop.

The visual receptor, horizontal inhibitory neuronal model, visual sequence model, basic neuron model (perceptual model), general sequence model, sequence matching model, effector perceptual model, and logical perceptual model described above are all fundamental models of brain-inspired computing. These models not only function in this instance but also play roles in various brain-inspired computing functions. Any brain-inspired or neural computing systems implementing functionalities through coordinated combinations of these models should all fall within the protection scope of the present application.

The embodiments described in conjunction with the drawings illustrate the technical solution of the present application. However, those skilled in the art will readily appreciate that the protection scope of the neuron models of the present application is not limited to the specific implementations. Without departing from the principles of the application, those skilled in the art may make equivalent modifications or substitutions to related technical features, and all such modified or substituted technical solutions shall all fall within the protection scope of the present application.

Although the neuron model of the present application is explained through specific embodiments, those skilled in the art should understand that various transformations and equivalent alternatives may be made without departing from the scope of the application. The models and method steps described in the disclosed embodiments are not limited to implementation by electronic hardware, computer software, or a combination thereof. All implementations making modifications within the spirit of the invention shall be encompassed. Therefore, the present application is not limited to the specific embodiments disclosed, but should include all embodiments falling within the scope of the appended claims.

We claim:

1. A binocular vision depth computation system and a brain-inspired computation model, wherein the system and a construction method comprise:
step S1: receiving, by a visual receptor, external light stimuli to form a physical object boundary and generate color information and orientation information of the boundary;
step S2: generating, by a visual sequence model, a visual sequence pulse;
step S3: separating, by the visual receptor, visual color information from edge information, under minor and irregular reciprocating motion;
step S4: processing, extracting, and integrating the color information and orientation information of the object boundary to form local boundary neural pulse sequence information; and
step S5: performing sequence-synchronized matching detection on binocular object edge information to output stereoscopic information.

2. The system and model according to claim 1, wherein the step S1 comprises constructing a visual receptor, the visual receptor with a concave light-receptor structure whose inner surface is uniformly arranged with light-receiving units to convert optical signals into electrical signals; the binocular vision depth computation system employs a pair of visual receptors which simultaneously output color sequential information and boundary sequence information of an objective world; color contrast between foreground and background stimuli forms a logical boundary, which is referred to as an object boundary; the pair of visual receptors synchronously perform the minor and irregular reciprocating motions, resulting in background stimuli in the pair of visual receptors to continuously vary; when the pair of visual receptors synchronously perform t irregular reciprocating motions, light-receptors at each point along a boundary formed between foreground objects and background are continuously, sequentially, and intermittently excited, thereby forming varying sequence information of the boundary; a straight line in the objective world is imaged as a curve on the visual receptors; when the visual receptors synchronously perform the minor and irregular reciprocating motions, a rate of color variation differs at each point along the imaged curve on the visual receptors; different rates of color variation along the boundary on the visual receptors comprises orientation information about the object boundaries in the objective world.

3. The system and model according to claim 1, wherein the step S2 comprises constructing a horizontal inhibitory neuron and a visual sequence model, after a pulse signal is received from any input pathway, a horizontal convergence unit of the horizontal inhibitory neuron suppresses signals from other input pathways; after a certain interval, a horizontal inhibitory neuron suppresses a current input signal and may receive signals from other pathways, thereby establishing loop alternation where input signals successively access the horizontal inhibitory neuron, the visual sequence model comprises one horizontal inhibitory neuron interconnected with multiple visual input pathways; and the visual sequence model receives and processes visual signals and outputs the processed visual signals.

4. The system and model according to claim 1, wherein the step S3 comprises: constructing an excitatory artificial neuron for receiving an excitatory input and outputting an excitatory signal; constructing an inhibitory artificial neuron for receiving an excitatory input and outputting an inhibitory signal; constructing an artificial neuron network comprising an excitatory artificial neuron and an inhibitory artificial neuron interconnected through input/output pathways, wherein all artificial neurons in the artificial neuron network possess a potential to connect with other artificial neurons; constructing a basic neuron model (perception model), also referred to as a local mesoscopic basic model, which comprises an excitatory source neuron, an excitatory target neuron and an inhibitory neuron interconnected; wherein when an external stimulus signal is receive in the basic neuron model (perceptron model), an interconnected loop is formed; under an action of the loop, a pathway between the source neuron and the target neuron achieves high-frequency signal transmission and sustained signal accumulation in the target neuron, thereby enhancing transmission efficiency; and the basic neuron model realizes signal separation and output under the action of the inhibitory loop.

5. The system and model according to claim 1, wherein the step S4 comprises: constructing a general sequence model which have a plurality of sequentially excited excitatory neurons connected in series and output a sequence signal after processing them; a basic neuron model (perception model) at an edge/boundary is stimulated to continuously activate the general sequence model; points along the edge/boundary sequentially activate the general sequence model to form a composite edge sequence pulse, which comprises color sequence information of the edge and orientation sequence information of the edge, a basic neuron model (perceptual model) within uniform regions is stimulated to activate a sequence matching model and the general sequence model, thereby generating a regionally unified color information sequence; under integration of the general sequence model and the sequence matching model, all color sequences within the regions are merged into an original color sequence output which is color perception mode output.

6. The system and model according to claim 1, wherein the step S5 comprises: constructing a sequence matching model comprising two connected general sequence models, wherein each general sequence model comprises an excitatory neuron sequence chain; after processing, the sequence matching model outputs an original sequence signal; the sequence-synchronized matching detection of binocular edge information requires processing by the sequence matching model to implement stereoscopic information output; the system receives inputs from two visual receptors where two edge sequences are generated; because the two sequences are processed independently, the two sequences are the same sequence yet asynchronous; under an action of these two same-sequence yet asynchronous edge sequences, the sequence matching model operates to form a new activation pattern and output the original sequence; when the two edge sequences are not the same sequence, the sequence matching model produces no output; under an action of two approximately same-sequence sequences, the sequence matching model outputs a short sequence; outputting the original sequence represents foreground depth disparity, and outputting the short sequence represents foreground-background spacing.

7. An effector perception model, wherein an interaction between an external effector (for example a joint formed by muscles and bones) and an internal neural network is formed as neuronal action patterns or memories within the neural network, that is, an efficient connection is established between sensory neurons and motor planning neurons; the external effector form a loop connection with the sensory neurons and the action planning neurons; a signal formed under a stimulus are transmitted at high frequency in the loop; a neuronal connection between the sensory neurons and the motion planning neurons become efficient under an action of the high-frequency signals.

8. A logical perception model, wherein an interaction between external logic and an internal neural network forms an logical association within the neural network, an operation of the external logic forms a loop connection with the neural network, a signal driven by a stimulus is transmitted at high frequency in the loop; inter-neuron connections mapped from the logical cause-and-effect relationship within the neural network become efficient under the action of the high-frequency signals.

9. A binocular vision depth computation system and a brain-inspired computation model, wherein a pair of visual receptors perform the minor and irregular reciprocating motions to input stimuli into the neural network; a disparity signal is output through coordinative processing of the visual receptor, the horizontal inhibitory neuron model, the visual sequence model, the basic neuron model (perception model), the general sequence model, and the sequence matching model; the visual receptor, the horizontal inhibitory neuron model, the visual sequence model, the basic neuron model (perception model), the general sequence model, the sequence matching model, the effector perception model, and the logical perception model are basic brain-inspired computation models.
